(19) United States
(12) Patent Application Publication
(10) Pub. No.: US 2025/0297151 A1
(43) Pub. Date: Sep. 25, 2025

(54) ICE CONTROL COMPOSITIONS AND USE THEREOF

(71) Applicant: Moxiyo, LLC, Herriman, UT (US)

(72) Inventor: Pete FULLER, West Jordan, UT (US)

(21) Appl. No.: 19/032,562

(22) Filed: Jan. 21, 2025

Related U.S. Application Data
(60) Provisional application No. 63/622,167, filed on Jan. 18, 2024.

(51) Int. Cl. C09K 3/18

(52) U.S. Cl. CPC C09K 3/18

(57) ABSTRACT

An ice melt composition can be distributed across a surface resulting in melting of at least a portion of ice on the surface or prevention of ice formation on the surface. The ice melt composition can include a sodium carbonate mineral. The composition can optionally further include a carboxylic acid, ice melt adjusters, fillers, stabilizers, colorants, binders, and the like. The carbonate mineral and carboxylic acid can be provided as a mixture of dry powders where each component is non-bonded and freely flowing from one another. Optionally, the components can be bound together to form larger composite particles such as grains, pellets, etc. The ice melt composition can be provided as a dry granular composition or a liquid composition.

### RELATED APPLICATION

This application claims priority to U.S. Provisional Application No. 63/622,167, filed Jan. 18, 2024 which is incorporated herein by reference.

### BACKGROUND

Trona is a mineral found in various locations including California, Wyoming, Botswana, Egypt, and elsewhere. Trona can be formed by reactions of late magmatic fluids with earlier crystallized rocks or by vapor unmixing. The structure of trona includes three edge-sharing sodium polyhedral cross-linked by carbonate groups and hydrogen bonds. Trona has a wide range of uses including glass manufacturing, chemical manufacturing, paper manufacturing, therapeutics, and the like.

### SUMMARY

A method of controlling ice can include distributing an ice melt composition onto a surface. The ice melt composition can include a sodium carbonate mineral. In some cases, the composition can further comprise a carboxylic acid, ice melt adjusters, fillers, stabilizers, colorants, binders, and the like. For example, in some cases the ice melt composition can be a granular composition where carbonate mineral and carboxylic acid can be provided as a mixture of powders where each component is non-bonded and freely flowing from one another. However, in some cases the components can be bound together to form larger particles such as grains, pellets, etc. In those cases, an optional water-soluble binder can be used as an example. In still other cases, the ice melt compositions can further include water to form a liquid composition which can be sprayed or otherwise distributed onto the surface.

Ice melting kits can include an ice melt composition including a sodium carbonate mineral and instructions. The instructions can include distributing an amount of the ice melt composition onto a surface sufficient to at least partially melt the iced surface.

There has thus been outlined, rather broadly, the more important features of the disclosure so that the detailed description thereof that follows may be better understood, and so that the present contribution to the art may be better appreciated. Other features of the present disclosure will become clearer from the following detailed description of the disclosure, taken with the accompanying drawings and claims, or may be learned by the practice of the disclosure.

### DETAILED DESCRIPTION

While these exemplary embodiments are described in sufficient detail to enable those skilled in the art to practice the disclosure, it should be understood that other embodiments may be realized and that various changes to the disclosure may be made without departing from the spirit and scope of the present disclosure. Thus, the following more detailed description of the embodiments of the present disclosure is not intended to limit the scope of the disclosure, as claimed, but is presented for purposes of illustration only and not limitation to describe the features and characteristics of the present disclosure, to set forth the best mode of operation of the disclosure, and to sufficiently enable one skilled in the art to practice the disclosure. Accordingly, the scope of the present disclosure is to be defined solely by the appended claims.

### Definitions

In describing and claiming the present disclosure, the following terminology will be used.

The singular forms “a,” “an,” and “the” include plural referents unless the context clearly dictates otherwise. Thus, for example, reference to “an acid” includes reference to one or more of such materials and reference to “mixing” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%. Furthermore, it is to be understood that in this written description support for actual numerical values is provided even when the term “about” is used therewith. For example, the recitation of “about” 30 should be construed as not only providing support for values a little above and a little below 30, but also for the actual numerical value of 30 as well.

As used herein with respect to an identified property or circumstance, “substantially” refers to a degree of deviation that is sufficiently small so as to not measurably detract from the identified property or circumstance. The exact degree of deviation allowable may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace materials present in a composition, but not affecting the compositions nature or characteristics would be permissible if present under the “consisting essentially of” language, even though not expressly recited in a list of items following such terminology. In the context of the present invention, “consisting essentially of” limits such trace elements to less than 2% by weight, and in some cases less than 0.5% by weight depending on the nature of those trace materials and whether they affect the ice melt properties described herein and is primarily referring to trace impurities which can be difficult or impossible to completely or economically remove. When using an open-ended term, like “comprising” or “including,” in the written description it is understood that direct support should be afforded also to “consisting essentially of” language as well as “consisting of” language as if stated explicitly and vice versa.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the disclosure should be determined solely by the appended claims and their legal equivalents, rather than by the descriptions and examples given herein.

Occurrences of the phrase “in one embodiment,” or “in one aspect,” or in one example,” herein do not necessarily all refer to the same embodiment or aspect.

### Carbonate Mineral Based Ice Melt Compositions and Use Thereof

An initial overview of disclosure embodiments is provided below and specific embodiments are then described in further detail. This initial summary is intended to aid readers in understanding the technological concepts more quickly, but is not intended to identify key or essential features thereof, nor is it intended to limit the scope of the claimed subject matter.

An ice melt composition can be distributed across a surface so as to at least partially melt ice on the iced surface. Such surfaces can include driveways, streets, runways, stairs, airplane control surfaces, sidewalks, patios, parking lots, athletic courts, playgrounds, automotive surfaces, and the like. In some cases, the ice melt composition can be distributed prior to formation of ice in order to prevent ice accumulation. In other cases, the ice melt composition can be distributed onto an iced surface to melt existing ice.

As a general guideline, the ice melt composition can be distributed at a rate of coverage and an amount sufficient to melt at least a portion of ice on the iced surface or to prevent ice formation. This rate can vary depending on the specific composition and conditions, especially temperature. Typically, colder temperatures will utilize higher coverage rates in order to achieve comparable results. However, in some cases the amount is 0.25 to 20 pounds per 1000 ft² at 30° F., in some cases 0.5 to 10 pounds per 1000 ft², in other cases 1.0 to 5 pounds per 1000 ft², and in some cases 0.2 oz/ft² to 1.0 oz/ft². This distributing can be performed using any suitable method depending on the particular application based on maneuverability, cost, surface area, and other factors. Non-limiting examples of suitable distribution techniques can include by hand, using a hand-pushed spreader, using a truck-mounted spreader, or by spraying.

The sodium carbonate mineral can include one or more of trona (sodium sesquicarbonate dihydrate, Na₂CO₃·NaHCO₃·2H₂O), gaylussite (a hydrated sodium calcium carbonate having the formula Na₂Ca(CO₃)₂·5H₂O), natron (a mixture including sodium carbonate decahydrate (Na₂CO₃·10H₂O), about 17% sodium bicarbonate (NaHCO₃), and small quantities of sodium chloride and sodium sulfate), prissonite (a sodium carbonate evaporite mineral, Na₂Ca(CO₃)₂·2(H₂O)), northupite (a sodium carbonate evaporite mineral, Na₃Mg(CO₃)₂Cl), nahcolite (sodium bicarbonate), thermonatrite (a sodium carbonate evaporite mineral, Na₂CO₃·H₂O), and combinations of these minerals. In one example, the sodium carbonate mineral is trona.

When the ice melt composition is provided as a dry granular composition, the sodium carbonate mineral can be provided as a granular, powder or particulate material. As a general guideline, an average D50 particle size of the sodium carbonate mineral can be less than about 6 mm, and in some cases less than about 3 mm.

Optionally, the ice melt composition can further comprise a carboxylic acid. The carboxylic acid can be one or more mono-, di- or tricarboxylic acids. The carboxylic acids may be any of a wide variety of mono-, di- and tricarboxylic acids. These carboxylic acids may be comprised of mono-, di-or tricarboxylic acids having the general formula:

(HOOC)—R13 (COOH)ₓ₋₁

where x is an integer of 1, 2 or 3, and R is a saturated or unsaturated, straight, or branched carbon chain having one to eighteen carbon atoms, or an aromatic moiety having six to eighteen carbon atoms which may be substituted or unsubstituted by OH, COOH, COOM, COOR′, —OR′ substituents, where M can be an alkali or alkaline earth metal, and where R′ can be saturated or unsaturated, straight, or branched carbon chain having from one to eight carbons, an aromatic moiety having six to eighteen carbon atoms which may be substituted by alkyl groups having one to eight carbons, OH, COOH, COOM, COOR', —OR′ substituents, and M can be an alkali or alkaline earth metal. For purposes described herein salicylic acid and citric acid are particularly useful carboxylic acids, although other carboxylic acids can also be used. Suitable carboxylic acids can be used singly or in combination with multiple carboxylic acids. Representative, but not inclusive, of such carboxylic acids can include monocarboxylic acids such as acetic acid, propionic acid, butyric acid, valeric acid, caproic acid, caprylic acid, capric acid, lauric acid, myristic acid, palmitic acid, stearic acid, myristoleic acid, palmitoleic acid, sapienic acid, oleic acid, a-linolenic acid, o-phthalic acid, isophthalic acid, terephthalic acid, acetylsalicylic acid, and salicylic acid. Non-limiting examples of dicarboxylic saturated and unsaturated acids can include oxalic acid, malonic acid, succinic acid, glutaric acid, adipic acid, pimelic acid, suberic acid, azelaic acid, sebacic acid, maleic acid, fumaric acid, glutaconic acid, and traumatic acid. Similarly, non-limiting examples of tricarboxylic acids can include citric acid, isocitric acid, propane-1,2,3-tricarboxylic acid, aconitic acid, and trimesic acid.

The ice melt composition can include the sodium carbonate mineral as the primary component. The sodium carbonate mineral can comprise greater than 50% by weight of the composition, in some cases greater than 75%, in other cases greater than 90%, in yet other cases greater than 95%, and in some cases 100%. In one example, trona can be present in the composition at a concentration of from about 60 wt % to about 100 wt %. In another example, the trona can be present in the composition at a concentration of from about 70 wt % to about 100 wt %. In another example, the trona can be present in the composition at a concentration of from about 95 wt % to about 100 wt %.

When carboxylic acid is included, the ratio of carbonate mineral to carboxylic acid may vary on a weight basis (w/w). Although other ratios may be useful, as a general guideline, the ratio can often range from 200:1 to 10:1. In some examples, the ice melt composition consists essentially or, or consists of, the sodium carbonate mineral, the carboxylic acid, and optionally water. In one case, the carboxylic acid is one or both of citric acid and salicylic acid. In another example, the carboxylic acid consists essentially of citric acid. When the ice melt composition is provided as a dry granular composition, the carboxylic acid can be provided as a dry particulate having an average D50 particle size of less than about 6 mm, in some cases less than 3 mm, and in other cases less than about 1 mm.

In one embodiment, the ice melt composition can further comprise optional additive ingredients can include, but are not limited to, fillers such as structural fillers and/or granular traction control fillers, ice melt adjusters, stabilizers, colorants, binders, and the like. Non-limiting examples of suitable traction control fillers can include sand, silica, and the like. Non-limiting examples of suitable ice melt adjusters can include one or more of magnesium chloride, calcium chloride, sodium chloride, calcium magnesium acetate, urea, sodium acetate, and the like. Non-limiting examples of suitable water-soluble binders can include carboxymethyl cellulose, microcrystalline cellulose, starch, hydroxypropyl methylcellulose, polyvinylpyrrolidone, pectin, polyethylene glycol, polyvinyl alcohol, and the like. These additives can collectively comprise a minority of the composition and are generally less than 50% by weight, in some cases 0.01% to 25%, in other cases 0.01% to 10%, in some examples 0.01% to 5%. As with other components, any additives can also be provided in a dry granular form. For example, additives can be provided as a dry particulate having an average D50 particle size of less than about 6 mm, in some cases less than 3 mm, and in other cases less than about 1 mm.

Regardless of additives, in some cases the components including the carbonate mineral, carboxylic acid and other additives can be provided as a mixture of powders where each component is non-bonded and freely flowing from one another. However, in some cases the components can be bound together to form larger composite particles such as grains, pellets, etc. In those cases, a water-soluble binder may be used as an example.

In one example, the ice melt compositions can be formed by providing particulate sodium carbonate mineral and optionally mixing in dry powder of any other additives and optional components. Due to differences in particle size and/or density in can be desirable to form particulate composite particles in order to provide more homogeneous distribution of ingredients. For example, a dry particulate trona, dry particulate citric acid, and a binder can be mixed together. The mixture can be made homogeneous and then pelletized, spray dried, grinded, or otherwise formed into discrete granules where each granule has multiple ingredients having a generally uniform composition among granules.

Although particle size can vary, in one example the particulate ice melt composition is a dry granular composition have an average D50 particle size of less than about 6 mm, in some cases, less than 3 mm, and in other cases less than 2 mm.

In another alternative, the sodium carbonate mineral and other optional additives can be mixed with water to form a solution in which components are dissolved or suspended as a liquid composition. Such liquid compositions can be conveniently sprayed, coated, or otherwise distributed onto the surfaces. This can be particularly useful on surfaces which are not horizontal where dry particulate may tend to fall away before melting ice, thus reducing effectiveness in ice melting or preventing ice formation. For example, airplane control surfaces, windows, mirrors, and the like can particularly benefit from a liquid ice melt composition.

The foregoing detailed description describes the disclosure with reference to specific exemplary embodiments. However, it will be appreciated that various modifications and changes can be made without departing from the scope of the present disclosure as set forth in the appended claims. The detailed description and accompanying drawings are to be regarded as merely illustrative, rather than as restrictive, and all such modifications or changes, if any, are intended to fall within the scope of the present disclosure as described and set forth herein.

What is claimed is:

1. A method of controlling ice, comprising distributing an ice melt composition onto a surface in an amount sufficient to melt at least a portion of ice on an iced surface or prevent formation of ice on the surface, wherein the ice melt composition comprises a sodium carbonate mineral.

2. The method of claim 1, wherein the surface is one or more of a sidewalk, a driveway, a street, a patio, stairs, a parking lot, runways, airplane control surfaces, an athletic court, a playground, and automotive surfaces.

3. The method of claim 1, wherein the distributing occurs by hand, using a hand-pushed spreader, using a truck-mounted spreader, spraying.

4. The method of claim 1, wherein the amount is 0.25 to 20 pounds per 1000 ft² at 30° F., in some cases 0.5 to 10 pounds per 1000 ft², in other cases 1.0 to 5 pounds per 1000 ft², and in some cases 0.2 oz/ft² to 1.0 oz/ft².

5. The method of claim 1, wherein the sodium carbonate mineral is a member selected from the group consisting of trona, gaylussite, natron, prissonite, northupite, nahcolite, thermonatrite, and combinations thereof.

6. The method of claim 1, wherein the sodium carbonate mineral is trona.

7. The method of claim 1, wherein the ice melt composition consists essentially of the sodium carbonate mineral.

8. The method of claim 1, further comprising a carboxylic acid which is a mono-, di- or tricarboxylic acid.

9. The method of claim 8, wherein the carboxylic acid is one or more of citric acid and salicylic acid.

10. The method of claim 8, wherein the composition consists essentially of the sodium carbonate mineral, the carboxylic acid, and optionally water.

11. The method of claim 10, wherein the carboxylic acid consists essentially of citric acid.

12. The method of claim 8, wherein the carboxylic acid is citric acid and the sodium carbonate mineral is trona and a w/w ratio of trona to citric acid is 200:1 to 10:1.

13. The method of claim 1, wherein the ice melt composition is a dry granular composition.

14. The method of claim 13, wherein the ice melt composition has an average D50 particle size of less than about 6 mm, in some cases, less than 3 mm, and in other cases less than 2 mm.

15. The method of claim 1, wherein the ice melt composition further comprises water to form a liquid composition.

16. An ice control kit, comprising:
an ice melt composition including a sodium carbonate mineral; and
instructions which specify distributing an amount of the ice melt composition onto a surface, wherein the amount is sufficient to at least partially melt an iced surface or to prevent formation of ice on the surface.

17. The kit of claim 16, wherein the amount is 0.2 oz/ft² to 1.0 oz/ft² or 0.25 to 20 pounds per 1000 ft² at 30° F.

18. The kit of claim 16, wherein the sodium carbonate mineral is a member selected from the group consisting of trona, gaylussite, natron, prissonite, northupite, nahcolite, thermonatrite, and combinations thereof.

19. The kit of claim 16, wherein one or more of:
the sodium carbonate mineral is trona;
the ice melt composition consists essentially of the sodium carbonate mineral;
the ice melt composition consists essentially of the sodium carbonate mineral, a carboxylic acid, and optionally water; and
the ice melt composition further comprises water and is in a liquid form.

20. The kit of claim 16, wherein the ice melt composition further comprises a carboxylic acid which is a mono-, di-or tricarboxylic acid, and wherein one of:
the carboxylic acid is one or more of citric acid and salicylic acid;
the carboxylic acid consists essentially of citric acid; and
the carboxylic acid is citric acid and the sodium carbonate mineral is trona and a w/w ratio of trona to citric acid is 200:1 to 10:1.

21. The kit of claim 16, wherein the ice melt composition is a dry granular composition have an average D50 particle size of less than about 3 mm.

22. The kit of claim 16, wherein the composition further comprises a granular traction control filler.

23. The kit of claim 22, wherein the granular traction control filler is one or more of sand and silica.

24. The kit of claim 16, wherein the composition further comprises ice melt adjusters.

25. The kit of claim 24, wherein the ice melt adjusters include one or more of magnesium chloride, calcium chloride, sodium chloride, calcium magnesium acetate, urea, and sodium acetate.
